(19) United States
(12) Patent Application Publication
(10) Pub. No.: US 2026/0204607 A1
(43) Pub. Date: Jul. 16, 2026

(54) Composite Proton Exchange Membrane Composition and Method of Preparation

(71) Applicant: Saudi Arabian Oil Company, Dhahran (SA)

(72) Inventors: Ahmad D. HAMMAD, Dhahran (SA); Issam Thaher AMR, Al-Khobar (SA); Shiyu WANG, Dalian (CN); Shilong XU, Dalian (CN)

(21) Appl. No.: 18/893,393

(22) Filed: Sep. 23, 2024

(30) Foreign Application Priority Data
Sep. 18, 2024 (GR) 20240100635

(51) Int. Cl. H01M 8/1067; H01M 8/0289; H01M 8/1039; H01M 8/20

(52) U.S. Cl. CPC H01M 8/1067; H01M 8/0289; H01M 8/1039; H01M 8/20

(57) ABSTRACT

A method of preparing a membrane. The method includes: preparing an amino-functionalized polybenzimidazole (APBI) from precursors including a benzidine derivative, an aromatic dicarboxylic acid, and an aromatic carboxylic acid that includes an amino group substituent; preparing a perfluorosulfonic acid (PFSA) solution including a PFSA resin; adding the APBI to the PFSA solution to form a casting solution; pouring the casting solution onto a glass plate to form a layer of a casted solution on the glass plate; and drying the layer of the casted solution on the glass plate to form a membrane on the glass plate, the membrane including the APBI and the PFSA resin.

This application claims the benefit of priority to Greek Patent Application No. 20240100635, filed Sep. 18, 2024, the contents of which are incorporated by reference herein.

### TECHNICAL FIELD

This disclosure relates to composite proton exchange membrane composition and method of its preparation.

### BACKGROUND

A flow battery is an energy storage technology that stores power as chemical energy in flowing solutions from separate storage tanks, termed catholytes and anolytes. Flow batteries can be cheaper and more flexible than other competitors, for example, due to their low cost and scalability. In a flow battery, the electrolytes are circulated through electrochemical cells, where they are separated by an ion exchange membrane. Electricity is converted to chemical energy in the electrochemical cells for storage, and then released during discharge. Unique to flow batteries is the ability to independently vary energy and power capacity.

In a flow battery, a proton exchange membrane provides selective ion transport channels for protons, form battery circuits, and isolate the electrolyte on both sides to prevent other ions from passing through. Accordingly, membrane materials tailored for specific types of flow battery, for example, vanadium flow battery, with sufficient ion selectivity, electrochemical stability and mechanical strength are desired.

### SUMMARY

Implementations of a composite proton exchange membrane according to the present disclosure may include one or more of the following features. For example, implementations according to the present disclosure can improve the flow battery technology by overcoming the trade-off between proton conductivity and vanadium ion selectivity of conventional ion exchange membranes. The composite proton exchange membrane can also enable the long-term electrochemical and mechanical stability of the flow battery under high-temperature operation conditions.

An implementation described herein provides a method of preparing a membrane. The method includes: preparing an amino-functionalized polybenzimidazole (APBI) from precursors including a benzidine derivative, an aromatic dicarboxylic acid, and an aromatic carboxylic acid that includes an amino group substituent; preparing a perfluorosulfonic acid (PFSA) solution including a PFSA resin; adding the APBI to the PFSA solution to form a casting solution; pouring the casting solution onto a glass plate to form a layer of a casted solution on the glass plate; and drying the layer of the casted solution on the glass plate to form a membrane on the glass plate, the membrane including the APBI and the PFSA resin.

In an aspect, combinable with any other aspect, the PFSA resin includes from 70 wt. % to 90 wt. % of a total weight of the membrane, and the APBI includes from 10 wt. % to 30 wt. % of the total weight of the membrane.

In an aspect, combinable with any other aspect, the benzidine derivative is 3,3-diaminobenzidine.

In an aspect, combinable with any other aspect, the aromatic dicarboxylic acid is m-phthalic acid.

In an aspect, combinable with any other aspect, the aromatic carboxylic acid includes the amino group substituent is 5-aminobenzoic acid.

In an aspect, combinable with any other aspect, preparing the APBI includes: adding the benzidine derivative to a polyphophoric acid to form a precursor solution; stirring the precursor solution at a first temperature from 100° C. to 150° C.; adding the aromatic dicarboxylic acid and the aromatic carboxylic acid having the amino group substituent to the precursor solution; stirring the precursor solution at a second temperature from 200° C. to 250° C.; neutralizing the precursor solution by adding a basic solution to the precursor solution; recovering a solid product from the precursor solution; drying the solid product to form the APBI.

In an aspect, combinable with any other aspect, a molar ratio of the benzidine derivative, the aromatic dicarboxylic acid, and the aromatic carboxylic acid having an amino group substituent in the precursors is 10:9:1.

In an aspect, combinable with any other aspect, the precursor solution is stirred at the second temperature for from 3 h to 5 h.

In an aspect, combinable with any other aspect, the basic solution is an ammonia aqueous solution.

In an aspect, combinable with any other aspect, preparing the PFSA solution includes adding the PFSA resin into a solution of dimethyl sulfoxide.

In an aspect, combinable with any other aspect, the PFSA resin includes from 1 wt. % to 10 wt. % of a total weight of the PFSA solution.

An implementation described herein provides a membrane. The membrane can include: a perfluorosulfonic acid (PFSA) resin; and an amino-functionalized polybenzimidazole (APBI).

In an aspect, combinable with any other aspect, the membrane is prepared by a method including: preparing the APBI from precursors including a benzidine derivative, an aromatic dicarboxylic acid, and an aromatic carboxylic acid that includes an amino group substituent; preparing a PFSA solution including the PFSA resin; adding the APBI to the PFSA solution to form a casting solution; pouring the casting solution onto a glass plate; and drying the glass plate to form the membrane on the glass plate.

In an aspect, combinable with any other aspect, the PFSA resin includes from 70 wt. % to 90 wt. % of a total weight of the membrane, and the APBI includes from 10 wt. % to 30 wt. % of the total weight of the membrane.

In an aspect, combinable with any other aspect, the benzidine derivative is 3,3-diaminobenzidine, the aromatic dicarboxylic acid is m-phthalic acid, and the aromatic carboxylic acid having the amino group substituent is 5-aminobenzoic acid.\

An implementation described herein provides a flow cell battery. The flow cell battery can include: an electrochemical cell, the electrochemical cell including: a composite proton exchange membrane including a perfluorosulfonic acid (PFSA) resin, and an amino-functionalized polybenzimidazole (APBI); an anode; an anode current collector electrically connected to the anode; a first flow frame disposed between the composite proton exchange membrane and the anode current collector, the first flow frame defining a plurality of first flow channels; a first tank including an anolyte, the anolyte including V⁴⁺ and V⁵⁺; a first pump configured to flow the anolyte from the first tank into the plurality of first flow channels; a cathode; a cathode current collector electrically connected to the cathode; a second flow frame disposed between the composite proton exchange membrane and the cathode current collector, the second flow frame defining a plurality of second flow channels; a second tank including a catholyte, the catholyte including V²⁺ and V³⁺; and a second pump configured to flow the catholyte from the second tank into the plurality of second flow channels.

In an aspect, combinable with any other aspect, the PFSA resin includes from 70 wt. % to 90 wt. % of a total weight of the composite proton exchange membrane, and the APBI includes from 10 wt. % to 30 wt. % of the total weight of the composite proton exchange membrane.

In an aspect, combinable with any other aspect, the electrochemical cell is configured to generate a current at a current density from 150 mA/cm² to 250 mA/cm².

In an aspect, combinable with any other aspect, a coulomb efficiency of the flow cell battery is at least 95% at a current density of 160 mA/cm² at 50° C.

In an aspect, combinable with any other aspect, the APBI is prepared from precursors including 3,3-diaminobenzidine, m-phthalic acid, and 5-aminobenzoic acid.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF DRAWINGS

FIG. 1 illustrates an example implementation of a flow battery electrochemical cell.

FIG. 2 illustrates components for a flow channel structure of an example implementation of a flow battery electrochemical cell.

FIG. 3 illustrates perfluorooctanesulfonic acid as an example fragment of perfluorosulfonic acid (PFSA) resin in a composite proton exchange membrane.

FIG. 4 illustrates an example amino-functionalized polybenzimidazole for a composite proton exchange membrane.

FIG. 5 illustrates a process flow chart of an example method of preparing a composite proton exchange membrane.

### DETAILED DESCRIPTION

Implementations described herein provide composite proton exchange membrane compositions and methods of preparation thereof. In a flow battery system, a proton exchange membrane is an important component that provides ion transport channels to form battery circuits and also hydraulically isolates the electrolytes on the anode side and the cathode side. For example, in a vanadium-based flow battery, the passage of vanadium ions through the membrane is to be prevented. Accordingly, the proton exchange membrane requires both excellent proton conductivity and ion selectivity. With the cost and low ion selectivity of conventional membranes such as perfluorinated sulfonic acid (PFSA) membrane, it is desired to develop new membrane materials to improve the ion selectivity without compromising the proton conductivity.

Various implementations described in this disclosure use a novel composite material for the proton exchange membrane in a flow battery system to improve the ion selectivity. In example implementations, the composite proton exchange membrane is a composite material including a PFSA resin and a secondary polymer component to improve the ion selectivity. An example of the secondary polymer component includes an amino-functionalized polybenzimidazole (APBI). In an example implementation, the vanadium ion permeability can be lowered to about 3.68×10⁻⁷ cm²·min⁻¹. Using the proton exchange membrane described in this disclosure, the proton ion selectivity can be improved to 90% or greater. The ion selectivity can be up to about 2.42×10⁵ S·min·cm⁻³. Further, the composite proton exchange membrane can offer an excellent proton conductivity as well as the long-term stability of the flow battery under high-temperature operation conditions, for example, at 50° C. for over 2000 cycles for at least 30 days.

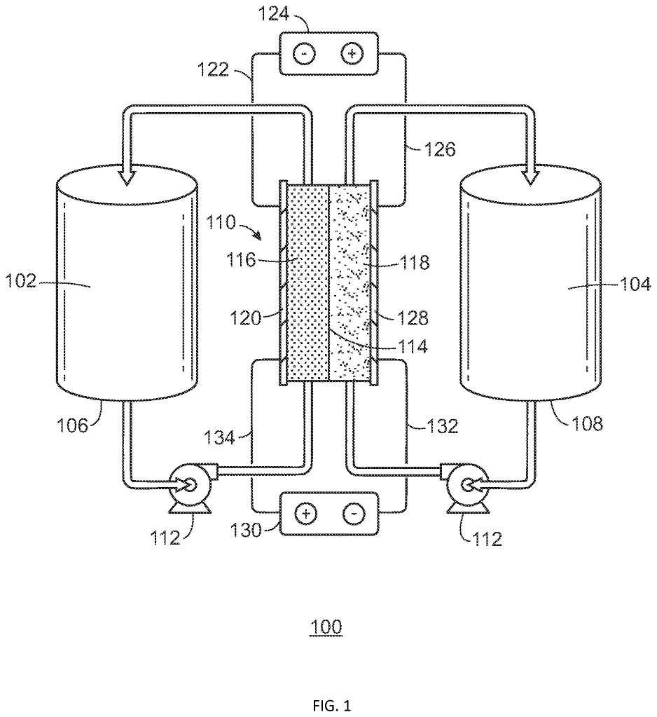

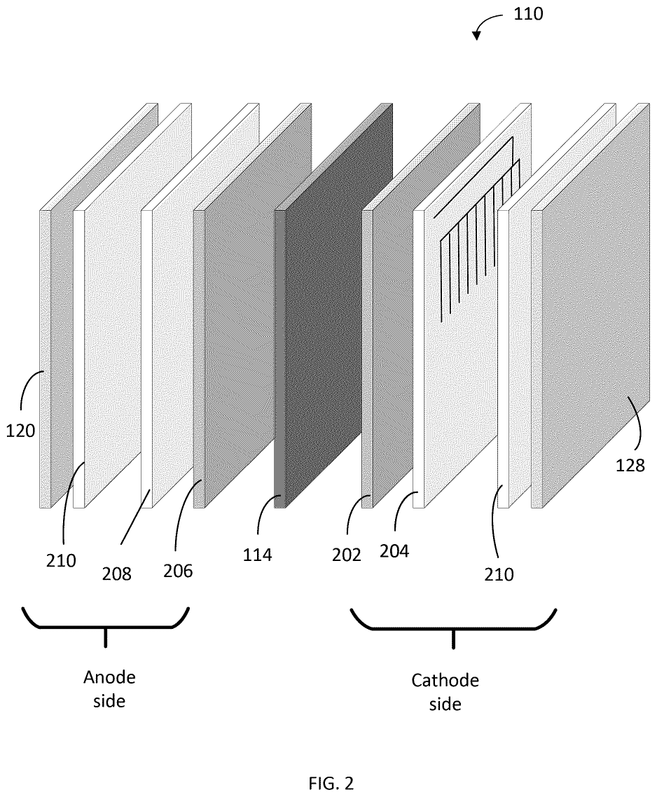

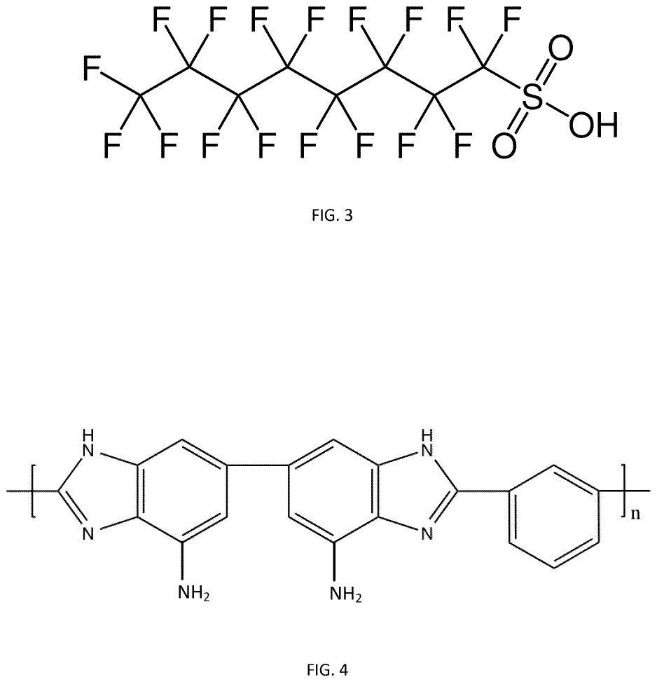

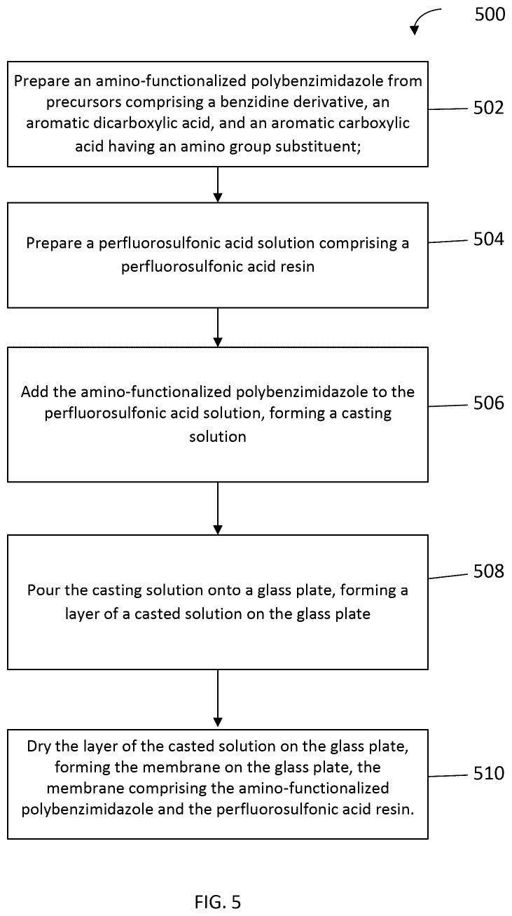

In the following, the design of an example implementation of an electrochemical cell for a flow battery including a composite proton exchange membrane is described referring to FIGS. 1-2. Molecular structures of example precursor for preparing the composite proton exchange membrane are illustrated in FIGS. 3-4. In FIG. 5, a process chart of an example method of preparing the composite proton exchange membrane is described.

FIG. 1 is a drawing of a flow battery 100 using two electrolytes. In the flow battery 100, the energy is stored in electrolytes 102 and 104, which are termed anolyte 102 and catholyte 104, herein. The electrolytes 102 and 104 are stored in tanks 106 and 108 and are separately pumped from the tanks 106 and 108 to an electrochemical cell 110 by dedicated pumps 112.

As illustrated in FIG. 1, a composite proton exchange membrane 114 can be used in the electrochemical cell 110. The composite proton exchange membrane 114 separates the electrolytes 102 and 104 to prevent energy loss by short-circuiting, while allowing protons, or other ions, to pass between the sides during charge and discharge cycles and maintain electroneutrality. The composite proton exchange membrane 114 controls the efficiency of the flow battery 100, and is a significant contributor to the cost of the flow battery 100.

As the electrolytes 102 and 104 are pumped through the electrochemical cell 110, they pass through channels 116 and 118. The channels 116 and 118 may include a porous electrode material, such as felt, or Rainey nickel, among others, to allow ions and electrons to flow between the electrolytes 102 and 104. In example implementations, for example, when the composite proton exchange membrane 114 is omitted, the channels 116 and 118 may be narrow to enhance laminar flow.

During the production of power, ions in the anolyte 102 are oxidized, losing electrons to the anode current collector 120. The electrons are transferred by a line 122 to a load 124. After powering the load 124, the electrons are returned to the electrochemical cell 110 by another line 126. The electrons reenter the electrochemical cell 110 from the cathode current collector 128, reducing ions in the catholyte 104.

In various implementations, the flow battery 100 is based on vanadium redox chemistry and is termed the vanadium redox flow battery (VFB). In VFBs, vanadium ions are dissolved in an aqueous acid supporting electrolyte. In example implementations, VFBs are based on V²⁺/V³⁺ and V⁴⁺/V⁵⁺ redox couples.

For a vanadium ion flow cell battery, during discharge, the reaction of the anolyte 102 at the anode current collector 120 is shown in equation 1.

$${V}^{2 +} \to {V}^{3 +} + {e}^{-} , {E}^{0} = - 0.25 V V s SH E \qquad ( 1 )$$

During discharge, the reaction of the catholyte 104 at the cathode current collector 128 is shown in equation 2.

$${VO}^{2 +} + 2 {H}^{+} + {e}^{-} \to {VO}^{2 +} + {H}_{2} O , {E}^{0} = + 1.01 V V s SH E \qquad ( 2 )$$

The anolyte 102 and the catholyte 104 are regenerated during a charging cycle. During the charging cycle a power source 130 removes electrons from the cathode current collector 128 through a line 132, oxidizing ions in the catholyte 104 to an initial state, for example, in the reverse of equation 2. The electrons are provided to the anode current collector 120 from the power source 130 through another line 134, reducing ions in the anolyte 102 to an initial state, for example, in the reverse of equation 1.

The composite proton exchange membrane of this disclosure can also be applied to any flow batteries that do not use vanadium redox chemistry. Further, it can also be applied as a proton exchange membrane to other electrochemical systems such as fuel cells, electrolyzers, and sensors.

FIG. 2 is a drawing of an electrochemical cell 110 illustrating components for a flow channel structure. Like numbered items are as described with respect to FIG. 1 and thus not repeated in detail. In various implementations, the flow channel structure enables flow passage of the anolyte 102 and the catholyte 104 for charging and discharging.

As illustrated in FIG. 2, the electrochemical cell 110 can include an anode side and a cathode side separated by the composite proton exchange membrane 114, and each side can be made of a set of similar or same components. In example implementations, the cathode side includes a cathode 202, a cathode flow frame 204, and a cathode current collector 128. The anode side can include an anode 206, an anode flow frame 208, an anode current collector 120. Further, in example implementations, bipolar plates 210 can be inserted between the flow frames 204, 208 and the current collectors 120, 128 in one or both sides as illustrated in FIG. 2. The bipolar plates 210 can serve as a separator from the anode side and cathode side when stacking multiple electrochemical cells. One purpose of the bipolar plate 210 is to allow the stacking of the electrochemical cells 110 for multiplied power generation while preventing ultra-high voltage breakdown.

In various implementations, the current collectors, 120, 128 can be highly conductive materials. In example implementations, the current collectors include or are made of metals, for example, copper and aluminum. The current collectors can be clamped to electrically insulating end plates and the bipolar plates 210. The wires for the circuitry of the battery system are connected to the current collectors.

In various implementations, the bipolar plates 210 can include a graphite composite plate.

In various implementations, the flow frames 204, 208, can include a highly conductive graphite material. The flow frames 204, 208 provide flow patterns to guide the electrolyte flow into the cell.

The anode 206 can include porous electrodes. In example implementations, the anode 206 can include or be made of a carbon-based electrode, for example, graphite felt, carbon paper or cloth, graphene, and graphitized carbon fiber (GCF).

In example implementations, the anode 206 has a thickness from 1 mm to 4 mm, for example, from 2 mm to 3 mm, or from 2.30 mm to 2.67 mm. In one implementation, the anode 206 has a thickness of 2.5 mm.

The cathode 202 can include porous electrodes. In example implementations, the cathode 202 can include or be made of a carbon-based electrode, for example, graphite felt, carbon paper or cloth, graphene, and graphitized carbon fiber (GCF).

In example implementations, the cathode 202 has a thickness from 1 mm to 4 mm, for example, from 2 mm to 3 mm, or from 2.30 mm to 2.67 mm. In one implementation, the cathode 202 has a thickness of 2.5 mm. In example implementations, the thickness of the anode 206 and the thickness of the cathode 202 are from 1 mm to 4 mm, for example, from 2 mm to 3 mm, from 2.30 mm to 2.67 mm, or 2.5 mm.

FIGS. 1 and 2 illustrate schematic diagrams of the flow battery 100 and the electrochemical cell 110, and in various implementations, components other than those described above can also be present, or some of the component in FIGS. 1 and 2 can be omitted. For example, the electrochemical cell 110 can include a housing element and a structural support to enable cell stacking.

The composite proton exchange membrane is a composite membrane material that can exhibit proton conductivity with ion selectivity, where the transport of other ions in the electrolytes 102 and 104, for example, vanadium ions, is limited. In example implementations, the composite proton exchange membrane includes a perfluorosulfonic acid (PFSA) resin and an amino-functionalized polybenzimidazole (APBI).

A PFSA resin is a polymer that incorporates the perfluorosulfonic acid groups into a resin matrix. For example, the PFSA can be synthesized via copolymerization, for example, tetrafluoroethylene (TFE) with a perfluoro vinyl ether containing sulfonic acid groups. In one or more implementations, the PFSA in the composite proton exchange membrane includes a sulfonated tetrafluoroethylene, for example, commercially available under the NAFION® name from DuPont Chemical of Wilmington Virginia. The type of PFSA to be incorporated in the PFSA resin can be varied and selected in consideration of the membrane performance. In FIG. 3, a molecular structure of perfluorooctanesulfonic acid as an example of PFSA is illustrated. Further, in one or more implementations, more than one type of PFSA resin can be used in the composite proton exchange membrane.

Although the PFSA resin itself can be used for a proton exchange membrane in a battery system, its poor ion selectivity becomes a challenge in certain types of battery. For example, in a vanadium-based flow battery system, the PFSA resin alone can suffer significant vanadium ion transmittance, which lowers the battery performance. The composite proton exchange membrane in this disclosure incorporates a secondary component, for example, APBI, to mitigate this issue of poor ion selectivity of the PFSA resin. Further, the use of the secondary component can reduce the material cost for preparing the proton exchange membrane.

The amount of the APBI in the composite proton exchange membrane can affect the ion selectivity. Ion selectivity can be calculated by the ratio of proton conductivity to ion permeability of another ion, for example, vanadium ions. With the increase of the APBI, the proton conductivity can decrease while the ability to prevent the penetration of the vanadium ions can increase. Accordingly, the amount of APBI mixed with the PFSA resin can be selected in view of the balance between the proton conductivity and the ion selectivity. In example implementations, the ion selectivity for proton over vanadium ions can be 90% or greater.

For example, the PFSA resin accounts for from 70 wt. % to 90 wt. % of the total weight of the composite proton exchange membrane, and the APBI accounts for from 10 wt. % to 30 wt. % of the total weight.

The APBI is prepared by functionalizing a polybenzimidazole (PBI) with one or more amine functional groups. The amine functionalization of the PBI can improve the proton conductivity. The molecular structure of an example APBI used for the composite proton exchange membrane is illustrated in FIG. 4. In the illustrated example, two amine groups are incorporated into a PBI unit structure.

The number and position of additional amine functional groups can be varied by modifying the precursors and preparation method. Further, in one or more implementations, more than one type of APBI can be used in the composite proton exchange membrane.

In example implementations, the procedure of preparing the APBI is as follows: adding (i) a benzidine derivative to a polyphophoric acid to form a precursor solution; stirring the precursor solution at a temperature from 100° C. to 150° C.; after dissolving the benzidine derivative in the precursor solution, adding (ii) an aromatic dicarboxylic acid and (iii) an aromatic carboxylic acid that includes an amino group substituent to the precursor solution; stirring the precursor solution at a temperature from 200° C. to 250° C. for a duration, for example, from 3 h to 5 h; neutralizing the precursor solution by adding a basic solution, for example, an ammonia aqueous solution, to the precursor solution; recovering a solid product from the precursor solution; and drying the solid product, for example, at a temperature from 60° C. to 100° C. for 12 h to 36 h, to form the APBI.

The benzidine derivative can be, for example, 3,3-diaminobenzidine. The aromatic dicarboxylic acid can be, for example, m-phthalic acid. The aromatic carboxylic acid having the amino group substituent can be, for example, 5-aminobenzoic acid.

In one or more implementations, a molar ratio of the benzidine derivative, the aromatic dicarboxylic acid, and the aromatic carboxylic acid that includes the amino group substituent in the precursors is 10:9:1. In one or more implementations, a molar ratio of the benzidine derivative to the aromatic dicarboxylic acid is from 2:1 to 1:2. In one or more implementations, a molar ratio of the benzidine derivative to the aromatic carboxylic acid that includes the amino group substituent is from 15:1 to 5:1. In one or more implementations, a molar ratio of the aromatic dicarboxylic acid to the aromatic carboxylic acid that includes the amino group substituent is from 15:1 to 5:1. biphenylimide was added to the polyphosphoric acid to make it fully mixed. After the biphenyl tetramine was completely dissolved, a certain amount of isophenic acid, 5-amino-isophenic acid.

Once the APBI is prepared, the composite proton exchange membrane can be prepared by incorporating the APBI into a PFSA resin. In example implementations, a PFSA solution including the PFSA resin is first prepared by adding the PFSA resin to a solvent. In one or more implementation, the solvent includes dimethyl sulfoxide (DMSO). The PFSA resin can account for from 1 wt. % to 10 wt. %, for example, about 5 wt. %, of the total weight of the PFSA solution. Subsequently, the APBI can be added to the PFSA solution to form a casting solution.

The casting solution including the APBI and the PFSA resin can be used to form the composite proton exchange membrane by a casting method or other suitable methods. The casting method can enable a continuous processing of material, leading to high production efficiency and high dimensional consistency. For example, the casting solution is poured onto a glass plate to form a thin layer of the casting solution on the glass plate, and the thin layer on the glass plate is then dried to form a membrane. In various implementations, in the obtained membrane, the PFSA resin accounts for from 70 wt. % to 90 wt. % of the total weight and the APBI accounts for from 10 wt. % to 30 wt. %.

After the membrane is shaped, acid doping is performed to replace sodium ions in the membrane with proton for providing a proton transport site. In various implementations, the membrane was soaked in an acidic solution, e.g., 3 M H₂SO₄ aqueous solution, at 40° C. for 24 h. The step of acid doping can be performed prior to assembling the membrane in a battery system.

FIG. 5 illustrates a process flow chart of an example method of preparing a composite proton exchange membrane. A method 500 starts with a step 502 by preparing an amino-functionalized polybenzimidazole (APBI) from precursors. The precursors can include a benzidine derivative, an aromatic dicarboxylic acid, and an aromatic carboxylic acid that includes an amino group substituent. After the step 502, a step 504 is performed to prepare a perfluorosulfonic acid solution including a perfluorosulfonic acid (PFSA) resin. Subsequently, a step 506 is performed to add the APBI to the perfluorosulfonic acid solution to form a casting solution. After the step 506, a step 508 is performed to pour the casting solution onto a glass plate to form a layer of a casted solution on the glass plate. After the step 508, a step 510 is performed to dry the layer of the casted solution on the glass plate to form a membrane on the glass plate. The obtained membrane includes the APBI and the PFSA resin.

### EXAMPLES

### Preparation of Amino-Functionalized Polybenzimidazole (APBI)

A set of three experiments in accordance with example implementations was performed for the amino-functionalization of a PBI as follows. In the first experiment, polyphosphoric acid was put into a four-mouth bottle under the protection of nitrogen, stirred, and heated at 130° C. for 1 h. Once the polyphosphoric acid became in a transparent liquid state, 1 mol of 3, 3-diaminobenzidine was added to the liquid to form a solution, and the temperature was controlled at 130° C. After the 3, 3-diaminobenzidine was completely dissolved in the solution, 0.9 mol of m-phthalic acid and 0.1 mol of 5-aminobenzoic acid were added to the solution. The solution was stirred and heat for 2 h, and the temperature was increased to 210° C. and held for 3 h. The resulting brown viscous liquid was discharged into excess water, and 100 ml of an ammonia aqueous solution was added to the solution for neutralization. The pH of the solution was evaluated with a pH paper to ensure that the pH was between 6.8 to 7.2. The solid product that precipitated was then washed several times with deionized (DI) water to remove the polyphosphoric acid and unreacted chemicals form the solid product. The solid product was then dried in an oven at 80° C. for 24 h. The dried solid was recovered as the APBI. The second and third experiments were performed following the same recipe as above except the stirring duration at 210° C. after adding the precursors; the solution was stirred for 4 h in the second experiment and 5 h in the third experiment.

In another example implementation, 65 g of polyphosphoric acid was poured into a four-port flask, and stirred at 130° C. for 2 h, and then 3 g of benzidine derivative was added to the polyphosphoric acid. After the benzidine derivative was completely dissolved, 2.1 g of aromatic dicarboxylic acid and 0.24 g of aromatic carboxylic acid that includes an amino group substituent, and 5 g of phosphorus pentoxide were added to the four-port flask and stirred. After 2 h, the solution was heated to 210° C. and held for 5 h. The reacted viscous solution is poured into cold water and neutralized with an ammonia aqueous solution until the solution became neutral. After the polyphosphoric acid and the unreacted reactants are completely removed from the solid product. The solid product was then dried in an oven at 80° C. for 24 h to obtain the APBI. The molar ratio of isophthalic acid to 5-amino-isophthalic acid was controlled at 9:1.

### Preparation of Composite Proton Exchange Membrane Using the APBI

In following example implementations, the APBI prepared by the third experiment above was used to prepare a composite proton exchange membrane. A PFSA resin was added to dimethyl sulfoxide (DMSO) to form a 5 wt. % PFSA solution, and then a powder of the APBI was dissolved into 5wt % PFSA solution and stirred to prepare a mixed solution containing the APBI and the PFSA resin at a certain ratio. Three compositions of the mixed solution were prepared: 90 wt. % PFSA resin-10 wt. % APBI, 80 wt. % PFSA resin-20 wt. % APBI, and 70 wt. % PFSA resin-30 wt. % APBI. The mixed solution was poured on a glass plate by a casting method, dried in a vacuum oven at 130° C. for 8 h, and cooled to room temperature to obtain the composite proton exchange membrane.

The composite proton exchange membranes obtained in the experiments above with three compositions were examined for ion permeability and battery performance.

The ion permeability was measured using a H-shaped diffusion cell. The first diffusion tank was filled with 50 mL of 1.5 M vanadyl sulfate/3 M sulfuric acid solution, and the second diffusion tank was filled with 50 mL of 1.5 M magnesium sulfate/3M sulfuric acid solution. The prepared membrane was used for isolating the two solutions in the middle. To avoid concentration polarization, rotors were added to the solutions on both sides of the diffusion cell to ensure the fluidity of the solutions. At regular intervals, 3 mL of the solution was removed from the second diffusion cell, and 3 mL of 1.5 M MgSO₄/3 M H₂SO₄ solution was added to maintain the permeation pressure balance on both sides. The concentration of VO²⁺ ions in the liquid from the second electrolytic cell was measured each time using a UV-Vis spectrometer with a scanning range of 500-800 nm.

Battery performance was measured at room temperature using an electrochemical workstation. The battery test was carried out by sandwiching a test membrane between two collectors. Prior to assembly, the membrane was soaked in a 3 M H₂SO₄ solution at 40° C. for 24 hours for acid doping. Using 70 mL 2 M V³⁺/VO²⁺ 3 M H₂SO₄ solution as the electrolyte solution for the negative and positive electrodes, the battery performance was evaluated at 160 mA cm⁻² current density. At 50° C., the vanadium ion permeability of the 80 wt. % PFSA resin-20 wt. % APBI proton exchange membrane was as low as 3.68×10⁻⁷ cm²·min⁻¹, and the coulomb efficiency (CE) was as high as 97.6% at 160 mA·cm⁻², while the CE of the pure PFSA membrane without any APBI modification was 96.5%. This result demonstrates the enhancing effect of the APBI incorporation on the battery performance. The CE of the 90 wt. % PFSA resin-10 wt. % APBI proton exchange membrane was 97.0%. The CE of the 70 wt. % PFSA resin-30 wt. % APBI proton exchange membrane was 95.9%. With the increase in the amount of APBI from 10 wt. % to 30 wt. %, the CE was slightly decreased, which can be attributed to the adverse effects of excessive APBI addition and uneven distribution in the membrane.

In one implementation, the composite proton exchange membrane can have a low area resistance below 0.5 Ω·cm², for example, about 0.1 Ω·cm².

In one implementation, the composite proton exchange membrane can have a high proton conductivity of at least 80 mS/cm, for example, about 80 mS/cm.

In one implementation, the composite proton exchange membrane can be used in a flow cell battery configured to generate a current at a current density from 150 mA/cm² to 250 mA/cm², for example, 160 mA/cm².

In one implementation, the composite proton exchange membrane can be electrochemically and mechanically stable for 30 days of immersion in a high state-of-charge (SOC) electrolyte with the weight loss of 1 wt. % or less, for example, about 0.5 wt. %. Examples of the high SOC electrolyte include sulfuric acid electrolytes and mixed acid electrolytes.

In one implementation, the composite proton exchange membrane can exhibit a high temperature resistance. For example, the composite proton exchange membrane does not show any substantial degradation after an operation of 2000 charge-discharge cycles at 50° C.

### IMPLEMENTATIONS

An implementation described herein provides a method of preparing a membrane. The method includes: preparing an amino-functionalized polybenzimidazole (APBI) from precursors including a benzidine derivative, an aromatic dicarboxylic acid, and an aromatic carboxylic acid that includes an amino group substituent; preparing a perfluorosulfonic acid (PFSA) solution including a PFSA resin; adding the APBI to the PFSA solution to form a casting solution; pouring the casting solution onto a glass plate to form a layer of a casted solution on the glass plate; and drying the layer of the casted solution on the glass plate to form a membrane on the glass plate, the membrane including the APBI and the PFSA resin.

In an aspect, combinable with any other aspect, the PFSA resin includes from 70 wt. % to 90 wt. % of a total weight of the membrane, and the APBI includes from 10 wt. % to 30 wt. % of the total weight of the membrane.

In an aspect, combinable with any other aspect, the benzidine derivative is 3,3-diaminobenzidine.

In an aspect, combinable with any other aspect, the aromatic dicarboxylic acid is m-phthalic acid.

In an aspect, combinable with any other aspect, the aromatic carboxylic acid includes the amino group substituent is 5-aminobenzoic acid.

In an aspect, combinable with any other aspect, preparing the APBI includes: adding the benzidine derivative to a polyphophoric acid to form a precursor solution; stirring the precursor solution at a first temperature from 100° C. to 150° C.; adding the aromatic dicarboxylic acid and the aromatic carboxylic acid having the amino group substituent to the precursor solution; stirring the precursor solution at a second temperature from 200° C. to 250° C.; neutralizing the precursor solution by adding a basic solution to the precursor solution; recovering a solid product from the precursor solution; drying the solid product to form the APBI.

In an aspect, combinable with any other aspect, a molar ratio of the benzidine derivative, the aromatic dicarboxylic acid, and the aromatic carboxylic acid having an amino group substituent in the precursors is 10:9:1.

In an aspect, combinable with any other aspect, the precursor solution is stirred at the second temperature for from 3 h to 5 h.

In an aspect, combinable with any other aspect, the basic solution is an ammonia aqueous solution.

In an aspect, combinable with any other aspect, preparing the PFSA solution includes adding the PFSA resin into a solution of dimethyl sulfoxide.

In an aspect, combinable with any other aspect, the PFSA resin includes from 1 wt. % to 10 wt. % of a total weight of the PFSA solution.

An implementation described herein provides a membrane. The membrane can include: a perfluorosulfonic acid (PFSA) resin; and an amino-functionalized polybenzimidazole (APBI).

In an aspect, combinable with any other aspect, the membrane is prepared by a method including: preparing the APBI from precursors including a benzidine derivative, an aromatic dicarboxylic acid, and an aromatic carboxylic acid that includes an amino group substituent; preparing a PFSA solution including the PFSA resin; adding the APBI to the PFSA solution to form a casting solution; pouring the casting solution onto a glass plate; and drying the glass plate to form the membrane on the glass plate.

In an aspect, combinable with any other aspect, the PFSA resin includes from 70 wt. % to 90 wt. % of a total weight of the membrane, and the APBI includes from 10 wt. % to 30 wt. % of the total weight of the membrane.

In an aspect, combinable with any other aspect, the benzidine derivative is 3,3-diaminobenzidine, the aromatic dicarboxylic acid is m-phthalic acid, and the aromatic carboxylic acid having the amino group substituent is 5-aminobenzoic acid.\

An implementation described herein provides a flow cell battery. The flow cell battery can include: an electrochemical cell, the electrochemical cell including: a composite proton exchange membrane including a perfluorosulfonic acid (PFSA) resin, and an amino-functionalized polybenzimidazole (APBI); an anode; an anode current collector electrically connected to the anode; a first flow frame disposed between the composite proton exchange membrane and the anode current collector, the first flow frame defining a plurality of first flow channels; a first tank including an anolyte, the anolyte including V⁴⁺ and V⁵⁺; a first pump configured to flow the anolyte from the first tank into the plurality of first flow channels; a cathode; a cathode current collector electrically connected to the cathode; a second flow frame disposed between the composite proton exchange membrane and the cathode current collector, the second flow frame defining a plurality of second flow channels; a second tank including a catholyte, the catholyte including V²⁺ and V³⁺; and a second pump configured to flow the catholyte from the second tank into the plurality of second flow channels.

In an aspect, combinable with any other aspect, the PFSA resin includes from 70 wt. % to 90 wt. % of a total weight of the composite proton exchange membrane, and the APBI includes from 10 wt. % to 30 wt. % of the total weight of the composite proton exchange membrane.

In an aspect, combinable with any other aspect, the electrochemical cell is configured to generate a current at a current density from 150 mA/cm² to 250 mA/cm².

In an aspect, combinable with any other aspect, a coulomb efficiency of the flow cell battery is at least 95% at a current density of 160 mA/cm² at 50° C.

In an aspect, combinable with any other aspect, the APBI is prepared from precursors including 3,3-diaminobenzidine, m-phthalic acid, and 5-aminobenzoic acid.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of preparing a membrane, the method comprising:
preparing an amino-functionalized polybenzimidazole (APBI) from precursors comprising a benzidine derivative, an aromatic dicarboxylic acid, and an aromatic carboxylic acid that includes an amino group substituent;
preparing a perfluorosulfonic acid (PFSA) solution comprising a PFSA resin;
adding the APBI to the PFSA solution to form a casting solution;
pouring the casting solution onto a glass plate to form a layer of a casted solution on the glass plate; and
drying the layer of the casted solution on the glass plate to form a membrane on the glass plate, the membrane comprising the APBI and the PFSA resin.

2. The method of claim 1, wherein the PFSA resin comprises from 70 wt. % to 90 wt. % of a total weight of the membrane, and the APBI comprises from 10 wt. % to 30 wt. % of the total weight of the membrane.

3. The method of claim 1, wherein the benzidine derivative is 3,3-diaminobenzidine.

4. The method of claim 1, wherein the aromatic dicarboxylic acid is m-phthalic acid.

5. The method of claim 1, wherein the aromatic carboxylic acid includes the amino group substituent is 5-aminobenzoic acid.

6. The membrane of claim 1, wherein preparing the APBI comprises:
adding the benzidine derivative to a polyphophoric acid to form a precursor solution;
stirring the precursor solution at a first temperature from 100 °C to 150 °C;
adding the aromatic dicarboxylic acid and the aromatic carboxylic acid having the amino group substituent to the precursor solution;
stirring the precursor solution at a second temperature from 200 °C to 250 °C;
neutralizing the precursor solution by adding a basic solution to the precursor solution;
recovering a solid product from the precursor solution;
drying the solid product to form the APBI.

7. The method of claim 6, wherein a molar ratio of the benzidine derivative, the aromatic dicarboxylic acid, and the aromatic carboxylic acid having an amino group substituent in the precursors is 10:9:1.

8. The method of claim 6, wherein the precursor solution is stirred at the second temperature for from 3 h to 5 h.

9. The method of claim 6, wherein the basic solution is an ammonia aqueous solution.

10. The method of claim 1, wherein preparing the PFSA solution comprises adding the PFSA resin into a solution of dimethyl sulfoxide.

11. The method of claim 1, wherein the PFSA resin comprises from 1 wt. % to 10 wt. % of a total weight of the PFSA solution.

12. A membrane comprising:
a perfluorosulfonic acid (PFSA) resin; and
an amino-functionalized polybenzimidazole (APBI).

13. The membrane of claim 12, wherein the membrane is prepared by a method comprising:
preparing the APBI from precursors comprising a benzidine derivative, an aromatic dicarboxylic acid, and an aromatic carboxylic acid that includes an amino group substituent;
preparing a PFSA solution comprising the PFSA resin;
adding the APBI to the PFSA solution to form a casting solution;
pouring the casting solution onto a glass plate; and
drying the glass plate to form the membrane on the glass plate.

14. The membrane of claim 12, wherein the PFSA resin comprises from 70 wt. % to wt. % of a total weight of the membrane, and the APBI comprises from 10 wt. % to 30 wt. % of the total weight of the membrane.

15. The membrane of claim 13, wherein the benzidine derivative is 3,3-diaminobenzidine, the aromatic dicarboxylic acid is m-phthalic acid, and the aromatic carboxylic acid having the amino group substituent is 5-aminobenzoic acid.

16. A flow cell battery comprising:
an electrochemical cell, the electrochemical cell comprising:
a composite proton exchange membrane comprising
a perfluorosulfonic acid (PFSA) resin, and
an amino-functionalized polybenzimidazole (APBI);
an anode;
an anode current collector electrically connected to the anode;
a first flow frame disposed between the composite proton exchange membrane and the anode current collector, the first flow frame defining a plurality of first flow channels;
a first tank comprising an anolyte, the anolyte comprising V⁴⁺ and V⁵⁺;
a first pump configured to flow the anolyte from the first tank into the plurality of first flow channels;
a cathode;
a cathode current collector electrically connected to the cathode;
a second flow frame disposed between the composite proton exchange membrane and the cathode current collector, the second flow frame defining a plurality of second flow channels;
a second tank comprising a catholyte, the catholyte comprising V²⁺ and V³⁺; and
a second pump configured to flow the catholyte from the second tank into the plurality of second flow channels.

17. The flow cell battery of claim 16, wherein the PFSA resin comprises from 70 wt. % to 90 wt. % of a total weight of the composite proton exchange membrane, and the APBI comprises from 10 wt. % to 30 wt. % of the total weight of the composite proton exchange membrane.

18. The flow cell battery of claim 16, wherein the electrochemical cell is configured to generate a current at a current density from 150 mA/cm² to 250 mA/cm².

19. The flow cell battery of claim 16, wherein a coulomb efficiency of the flow cell battery is at least 95% at a current density of 160 mA/cm² at 50° C.

20. The flow cell battery of claim 16, wherein the APBI is prepared from precursors comprising 3,3-diaminobenzidine, m-phthalic acid, and 5-aminobenzoic acid.
